(19) United States
(12) Patent Application Publication
(10) Pub. No.: US 2022/0076158 A1
(43) Pub. Date: Mar. 10, 2022

(54) SYSTEM AND METHOD FOR A SMART ASSET RECOVERY MANAGEMENT FRAMEWORK

(71) Applicant: DELL PRODUCTS, LP, Round Rock, TX (US)

(72) Inventors: Harish Mysore Jayaram, Cedar Park, TX (US); Bijan Kumar Mohanty, Austin, TX (US); Alexandre Buchweitz, Porto Alegre (BR); Hung The Dinh, Austin, TX (US)

(21) Appl. No.: 17/015,162

(22) Filed: Sep. 9, 2020

(51) Int. Cl. G06N 20/00; G06F 16/951; G06F 16/22; G06Q 10/00; G06Q 20/08; G06Q 10/08; G06Q 30/02

(52) U.S. Cl. CPC G06N 20/00; G06F 16/951; G06F 16/2264; G06Q 30/0278; G06Q 10/30; G06Q 20/0855; G06Q 10/087; G06F 16/2246

(57) ABSTRACT

An information handling system receives historical data that includes configuration information and recovery values of recycled assets, and builds a training dataset from a subset of the historical data. The information handling system also builds a validation dataset from another subset of the historical data, and trains a machine learning model on the training dataset to learn the recovery values of the recycled assets. The system also validates the machine learning model based on the validation dataset, tunes a hyperparameter of the machine learning model, and predicts a recovery value of a recyclable asset using the machine learning model utilizing an extreme gradient boosting algorithm.

### FIELD OF THE DISCLOSURE

The present disclosure generally relates to information handling systems, and more particularly relates to a smart asset recovery management framework.

### BACKGROUND

As the value and use of information continues to increase, individuals and businesses seek additional ways to process and store information. One option is an information handling system. An information handling system generally processes, compiles, stores, or communicates information or data for business, personal, or other purposes. Technology and information handling needs and requirements can vary between different applications. Thus, information handling systems can also vary regarding what information is handled, how the information is handled, how much information is processed, stored, or communicated, and how quickly and efficiently the information can be processed, stored, or communicated. The variations in information handling systems allow information handling systems to be general or configured for a specific user or specific use such as financial transaction processing, airline reservations, enterprise data storage, or global communications. In addition, information handling systems can include a variety of hardware and software resources that can be configured to process, store, and communicate information and can include one or more computer systems, graphics interface systems, data storage systems, networking systems, and mobile communication systems. Information handling systems can also implement various virtualized architectures. Data and voice communications among information handling systems may be via networks that are wired, wireless, or some combination.

### SUMMARY

An information handling system receives historical data that includes configuration information and recovery values of recycled assets, and builds a training dataset from a subset of the historical data. The information handling system also builds a validation dataset from another subset of the historical data, and trains a machine learning model on the training dataset to learn the recovery values of the recycled assets. The system also validates the machine learning model based on the validation dataset, tunes a hyperparameter of the machine learning model, and predicts a recovery value of a recyclable asset using the machine learning model utilizing an extreme gradient boosting algorithm.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram illustrating an information handling system according to an embodiment of the present disclosure;

FIG. 2 is a block diagram illustrating an example of an environment for a smart asset recovery management framework, according to an embodiment of the present disclosure; and

FIG. 3 is a flowchart illustrating an example of a method for a smart asset recovery management framework, according to an embodiment of the present disclosure.

The use of the same reference symbols in different drawings indicates similar or identical items.

### DETAILED DESCRIPTION OF THE DRAWINGS

The following description in combination with the Figures is provided to assist in understanding the teachings disclosed herein. The description is focused on specific implementations and embodiments of the teachings and is provided to assist in describing the teachings. This focus should not be interpreted as a limitation on the scope or applicability of the teachings.

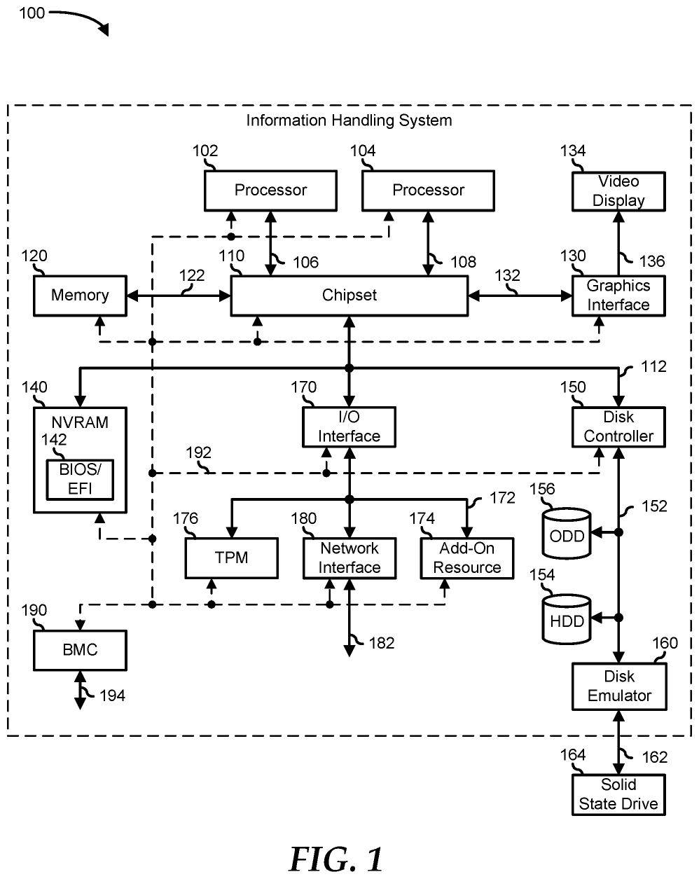

FIG. 1 illustrates an embodiment of an information handling system 100 including processors 102 and 104, a chipset 110, a memory 120, a graphics adapter 130 connected to a video display 134, a non-volatile RAM (NV-RAM) 140 that includes a basic input and output system/extensible firmware interface (BIOS/EFI) module 142, a disk controller 150, a hard disk drive (HDD) 154, an optical disk drive 156, a disk emulator 160 connected to a solid-state drive (SSD) 164, an input/output (I/O) interface 170 connected to an add-on resource 174 and a trusted platform module (TPM) 176, a network interface 180, and a baseboard management controller (BMC) 190. Processor 102 is connected to chipset 110 via processor interface 106, and processor 104 is connected to the chipset via processor interface 108. In a particular embodiment, processors 102 and 104 are connected together via a high-capacity coherent fabric, such as a HyperTransport link, a QuickPath Interconnect, or the like. Chipset 110 represents an integrated circuit or group of integrated circuits that manage the data flow between processors 102 and 104 and the other elements of information handling system 100. In a particular embodiment, chipset 110 represents a pair of integrated circuits, such as a northbridge component and a southbridge component. In another embodiment, some or all of the functions and features of chipset 110 are integrated with one or more of processors 102 and 104.

Memory 120 is connected to chipset 110 via a memory interface 122. An example of memory interface 122 includes a Double Data Rate (DDR) memory channel and memory 120 represents one or more DDR Dual In-Line Memory Modules (DIMMs). In a particular embodiment, memory interface 122 represents two or more DDR channels. In another embodiment, one or more of processors 102 and 104 include a memory interface that provides a dedicated memory for the processors. A DDR channel and the connected DDR DIMMs can be in accordance with a particular DDR standard, such as a DDR3 standard, a DDR4 standard, a DDRS standard, or the like.

Memory 120 may further represent various combinations of memory types, such as Dynamic Random Access Memory (DRAM) DIMMs, Static Random Access Memory (SRAM) DIMMs, non-volatile DIMMs (NV-DIMMs), storage class memory devices, Read-Only Memory (ROM) devices, or the like. Graphics adapter 130 is connected to chipset 110 via a graphics interface 132 and provides a video display output 136 to a video display 134. An example of a graphics interface 132 includes a Peripheral Component Interconnect-Express (PCIe) interface and graphics adapter 130 can include a four-lane (x4) PCIe adapter, an eight-lane (x8) PCIe adapter, a 16-lane (x16) PCIe adapter, or another configuration, as needed or desired. In a particular embodiment, graphics adapter 130 is provided down on a system printed circuit board (PCB). Video display output 136 can include a Digital Video Interface (DVI), a High-Definition Multimedia Interface (HDMI), a DisplayPort interface, or the like, and video display 134 can include a monitor, a smart television, an embedded display such as a laptop computer display, or the like.

NV-RAM 140, disk controller 150, and I/O interface 170 are connected to chipset 110 via an I/O channel 112. An example of I/O channel 112 includes one or more point-to-point PCIe links between chipset 110 and each of NV-RAM 140, disk controller 150, and I/O interface 170. Chipset 110 can also include one or more other I/O interfaces, including an Industry Standard Architecture (ISA) interface, a Small Computer Serial Interface (SCSI) interface, an Inter-Integrated Circuit (I²C) interface, a System Packet Interface (SPI), a Universal Serial Bus (USB), another interface, or a combination thereof. NV-RAM 140 includes BIOS/EFI module 142 that stores machine-executable code (BIOS/EFI code) that operates to detect the resources of information handling system 100, to provide drivers for the resources, to initialize the resources, and to provide common access mechanisms for the resources. The functions and features of BIOS/EFI module 142 will be further described below.

Disk controller 150 includes a disk interface 152 that connects the disc controller to a hard disk drive (HDD) 154, to an optical disk drive (ODD) 156, and to disk emulator 160. An example of disk interface 152 includes an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. Disk emulator 160 permits SSD 164 to be connected to information handling system 100 via an external interface 162. An example of external interface 162 includes a USB interface, an institute of electrical and electronics engineers (IEEE) 1394(Firewire) interface, a proprietary interface, or a combination thereof. Alternatively, SSD 164 can be disposed within information handling system 100.

I/O interface 170 includes a peripheral interface 172 that connects the I/O interface to add-on resource 174, to TPM 176, and to network interface 180. Peripheral interface 172 can be the same type of interface as I/O channel 112 or can be a different type of interface. As such, I/O interface 170 extends the capacity of I/O channel 112 when peripheral interface 172 and the I/O channel are of the same type, and the I/O interface translates information from a format suitable to the I/O channel to a format suitable to the peripheral interface 172 when they are of a different type. Add-on resource 174 can include a data storage system, an additional graphics interface, a network interface card (NIC), a sound/video processing card, another add-on resource, or a combination thereof. Add-on resource 174 can be on a main circuit board, on separate circuit board or add-in card disposed within information handling system 100, a device that is external to the information handling system, or a combination thereof

Network interface 180 represents a network communication device disposed within information handling system 100, on a main circuit board of the information handling system, integrated onto another component such as chipset 110, in another suitable location, or a combination thereof. Network interface 180 includes a network channel 182 that provides an interface to devices that are external to information handling system 100. In a particular embodiment, network channel 182 is of a different type than peripheral interface 172 and network interface 180 translates information from a format suitable to the peripheral channel to a format suitable to external devices.

In a particular embodiment, network interface 180 includes a NIC or host bus adapter (HBA), and an example of network channel 182 includes an InfiniBand channel, a Fibre Channel, a Gigabit Ethernet channel, a proprietary channel architecture, or a combination thereof. In another embodiment, network interface 180 includes a wireless communication interface, and network channel 182 includes a Wi-Fi channel, a near-field communication (NFC) channel, a Bluetooth or Bluetooth-Low-Energy (BLE) channel, a cellular based interface such as a Global System for Mobile (GSM) interface, a Code-Division Multiple Access (CDMA) interface, a Universal Mobile Telecommunications System (UMTS) interface, a Long-Term Evolution (LTE) interface, or another cellular based interface, or a combination thereof. Network channel 182 can be connected to an external network resource (not illustrated). The network resource can include another information handling system, a data storage system, another network, a grid management system, another suitable resource, or a combination thereof

BMC 190 is connected to multiple elements of information handling system 100 via one or more management interface 192 to provide out of band monitoring, maintenance, and control of the elements of the information handling system. As such, BMC 190 represents a processing device different from processor 102 and processor 104, which provides various management functions for information handling system 100. For example, BMC 190 may be responsible for power management, cooling management, and the like. The term BMC is often used in the context of server systems, while in a consumer-level device a BMC may be referred to as an embedded controller (EC). A BMC included at a data storage system can be referred to as a storage enclosure processor. A BMC included at a chassis of a blade server can be referred to as a chassis management controller and embedded controllers included at the blades of the blade server can be referred to as blade management controllers. Capabilities and functions provided by BMC 190 can vary considerably based on the type of information handling system. BMC 190 can operate in accordance with an Intelligent Platform Management Interface (IPMI). Examples of BMC 190 include an Integrated Dell® Remote Access Controller (iDRAC).

Management interface 192 represents one or more out-of-band communication interfaces between BMC 190 and the elements of information handling system 100, and can include an Inter-Integrated Circuit (I2C) bus, a System Management Bus (SMBUS), a Power Management Bus (PMBUS), a Low Pin Count (LPC) interface, a serial bus such as a Universal Serial Bus (USB) or a Serial Peripheral Interface (SPI), a network interface such as an Ethernet interface, a high-speed serial data link such as a Peripheral Component Interconnect-Express (PCIe) interface, a Network Controller Sideband Interface (NC-SI), or the like. As used herein, out-of-band access refers to operations performed apart from a BIOS/operating system execution environment on information handling system 100, that is apart from the execution of code by processors 102 and 104 and procedures that are implemented on the information handling system in response to the executed code.

BMC 190 operates to monitor and maintain system firmware, such as code stored in BIOS/EFI module 142, option ROMs for graphics adapter 130, disk controller 150, add-on resource 174, network interface 180, or other elements of information handling system 100, as needed or desired. In particular, BMC 190 includes a network interface 194 that can be connected to a remote management system to receive firmware updates, as needed or desired. Here, BMC 190 receives the firmware updates, stores the updates to a data storage device associated with the BMC, transfers the firmware updates to NV-RAM of the device or system that is the subject of the firmware update, thereby replacing the currently operating firmware associated with the device or system, and reboots information handling system, whereupon the device or system utilizes the updated firmware image.

BMC 190 utilizes various protocols and application programming interfaces (APIs) to direct and control the processes for monitoring and maintaining the system firmware. An example of a protocol or API for monitoring and maintaining the system firmware includes a graphical user interface (GUI) associated with BMC 190, an interface defined by the Distributed Management Taskforce (DMTF) (such as a Web Services Management (WSMan) interface, a Management Component Transport Protocol (MCTP) or, a Redfish® interface), various vendor defined interfaces (such as a Dell EMC Remote Access Controller Administrator (RACADM) utility, a Dell EMC OpenManage Server Administrator (OMSS) utility, a Dell EMC OpenManage Storage Services (OMSS) utility, or a Dell EMC OpenManage Deployment Toolkit (DTK) suite), a BIOS setup utility such as invoked by a “F2” boot option, or another protocol or API, as needed or desired.

In a particular embodiment, BMC 190 is included on a main circuit board (such as a baseboard, a motherboard, or any combination thereof) of information handling system 100 or is integrated onto another element of the information handling system such as chipset 110, or another suitable element, as needed or desired. As such, BMC 190 can be part of an integrated circuit or a chipset within information handling system 100. An example of BMC 190 includes an iDRAC, or the like. BMC 190 may operate on a separate power plane from other resources in information handling system 100. Thus BMC 190 can communicate with the management system via network interface 194 while the resources of information handling system 100 are powered off. Here, information can be sent from the management system to BMC 190 and the information can be stored in a RAM or NV-RAM associated with the BMC. Information stored in the RAM may be lost after power-down of the power plane for BMC 190, while information stored in the NV-RAM may be saved through a power-down/power-up cycle of the power plane for the BMC.

Information handling system 100 can include additional components and additional busses, not shown for clarity. For example, information handling system 100 can include multiple processor cores, audio devices, and the like. While a particular arrangement of bus technologies and interconnections is illustrated for the purpose of example, one of skill will appreciate that the techniques disclosed herein are applicable to other system architectures. Information handling system 100 can include multiple CPUs and redundant bus controllers. One or more components can be integrated together. Information handling system 100 can include additional buses and bus protocols, for example, I2C and the like. Additional components of information handling system 100 can include one or more storage devices that can store machine-executable code, one or more communications ports for communicating with external devices, and various input and output (I/O) devices, such as a keyboard, a mouse, and a video display.

For purpose of this disclosure information handling system 100 can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, information handling system 100 can be a personal computer, a laptop computer, a smartphone, a tablet device or other consumer electronic device, a network server, a network storage device, a switch, a router, or another network communication device, or any other suitable device and may vary in size, shape, performance, functionality, and price. Further, information handling system 100 can include processing resources for executing machine-executable code, such as processor 102, a programmable logic array (PLA), an embedded device such as a System-on-a-Chip (SoC), or other control logic hardware. Information handling system 100 can also include one or more computer-readable media for storing machine-executable code, such as software or data.

Asset recovery and recycling is a rapidly growing business with manufacturers paying fair market value, also referred to as a recovery value of a recycled asset to a customer. The recovery value paid to the customer may be a net recovery value after a service fee if applicable is applied. The recovery value compensation typically encourages a customer to recycle in addition to the satisfaction of being environmentally friendly. However, the recovery value is generally not known at the point when the recyclable asset is received from the customer because of the various factors that affect the recovery value such as type of the asset, configuration, and condition of the recyclable asset. A customer may wait for days or months for the recycling company to receive compensation, which reduces customer satisfaction and may discourage some customers from recycling. Thus, it is desirable to be able to determine the recovery value at the point of receipt of the recyclable asset or inquiry by the customer. The present disclosure includes a smart pricing engine that may determine the estimated fair value of the recyclable asset in real-time using artificial intelligence and/or machine learning techniques.

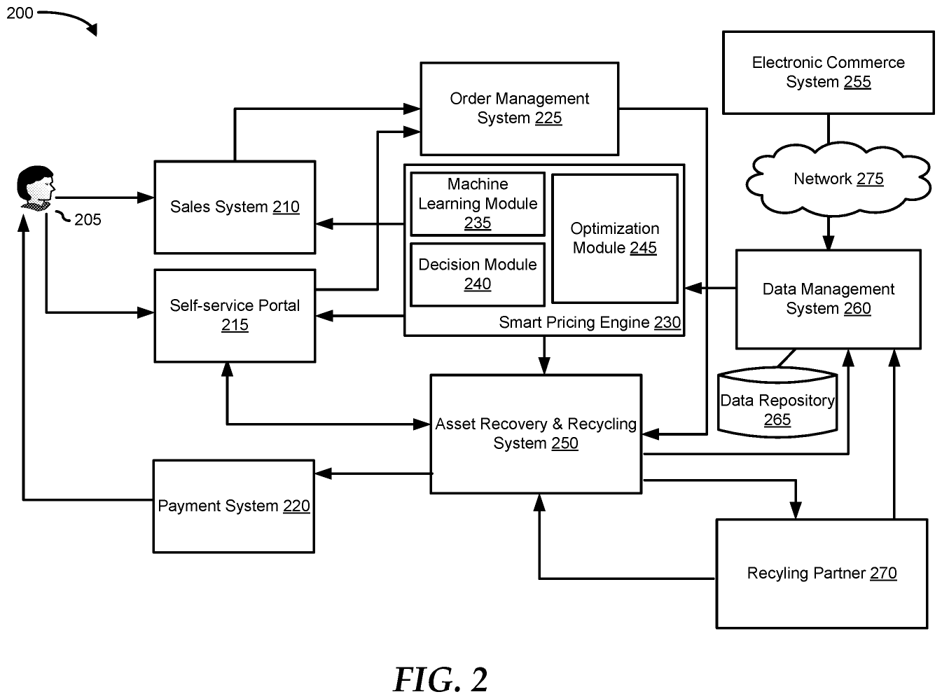

FIG. 2 illustrates an environment 200 for a smart asset recovery management framework that utilizes artificial intelligence and/or machine learning techniques such as extreme gradient boosting (XGB) algorithm. Environment 200 includes a sales system 210, a self-service portal 215, a payment system 220, an order management system 225, a smart pricing engine 230, an asset recovery and recycling system 250, an electronic commerce system 255, a network 275, a data management system 260, a data repository 265, and a recycling partner 270. Smart pricing engine 230 may be part of an information handling system similar to information handling system 100 of FIG. 1. Sales system 210, self-service portal 215, payment system 220, order management 225, asset recovery and recycling system 250, data management system 260 may also be part of the same information handling system that includes smart pricing engine 230. In another embodiment, the aforementioned may be external to the information handling system that includes smart pricing engine 230. Further, data management system 260 may be part of smart pricing engine 230.

A customer 205 typically utilizes sales system 210 or self-service portal 215 when submitting a request to recycle an asset. The recyclable asset may be of various types such as a desktop, a laptop, a camera, etc. Sales system 210 may have a sales agent that provides a quote for recovery value of the recyclable asset by using smart pricing engine 230. Similarly, self-service portal 215 may have an interface for customer 205 to interact and provide a quote for the recovery value of the recyclable asset by using smart pricing engine 230. Self-service portal 215 may transmit information associated with customer interaction such as the recovery value of the asset to asset recovery and recycling system 250. This value may also be used in training the model.

Order management system 225 may be configured to process and/or manage requests to recycle an asset from sales system 210 and self-service portal 215 after customer 205 places the request. Order management system 225 transmits the request to asset recovery and recycling system 250 which submits a request to recycling partners 270 to pick up the asset from the customer location and then recycle the asset. After the asset is recycled, recycling partner 270 sends the recovery value of the asset to asset recovery and recycling system 250 which deducts a fee such as service fee if applicable from the recovery value and pays customer 205 via payment system 220. Asset recovery and recycling system 250 may also be configured to use smart pricing engine 230 to calculate the recovery price of the recyclable asset after the recyclable asset is picked up by recycling partner 270.

Data management system 260 may be configured to build or generate a multidimensional dataset from one or more datasets such as historical settlement statements of recycled assets from asset recovery and recycling system 250, data harvested or crawled from Internet-based electronic commerce system 255, and data provided by recycling partner 270. In particular, data management system 260 may harvest additional recovery values or cost data on used assets from electronic commerce sites as e-Bay and Amazon as well as other recycling partners via network 275 that may be a public network, such as the Internet, a physical private network, a wireless network, a virtual private network (VPN), or any combination thereof.

The multidimensional dataset may include information associated with recycled assets such as a manufacturer name, a model number, a serial number, a service tag, a product type, processor information, disk drive information, memory information, etc. for each one of the recycled assets. Processor information may include the manufacturer name, a processor number, speed, etc. Disk drive information may include disk drive type, model number, speed, size, etc. The information may span over a period of time, such as over days, months, or years. Data management system 260 may retrieve the information periodically such as hourly, weekly, monthly, etc. Data management sytem 260 may also retrieve the information upon demand by a user or when detecting a trigger such as an update event. The data such as the historical data and data crawled or obtained from various sources may be stored in data repository 265 along with generated or built multidimensional datasets.

Data management system 260 may also be configured to build or generate a multidimensional training dataset from a subset of the multidimentsional dataset which is used to train a machine learning model. Data management system 260 may also be configured to build or generate a multidimensional validation or testing dataset from yet another subset of the multidimensional dataset which is used to validate or test the trained machine learning model. In one example, the training dataset is 80% of the multidimensional dataset while the validation dataset is 20% of the multidimensional dataset. The validation may result in an accuracy score, on how well the model predicted the recovery values of the recycled assets in the validation dataset. For example, the validation may indicate that the model is 90% accurate.

Optimization module 245 may be configured to optimize the accuracy of the model by tuning hyperparameters like max depth and samples on a leaf. For example, optimization module 245 may optimize the model if the accuracy threshold of the model has not been reached or to further increase the model's accuracy. For example, optimization module 245 may optimize the model of the accuracy is less than 90% or to increase the accuracy of the machine learning model to increase by a certain percentage or reach a certain percentage of accuracy such as to increase accuracy from 90% to 90% or increase by 10%.

Optimization module 245 may be configured to implement methods that are configured for setting and tuning hyperparameters of the deep learning model. As is known in the art, the hyperparameters includes parameters that define the model architecture and parameters which determine how the model is trained. The parameters that define the model architecture include a number of hidden layers while the parameters that determine how the model is trained to include a learning rate which defines a rate at which a model updates the model parameters.

Optimization module 245 may be configured to tune the hyperparameters of the machine learning model based on the validation results of the test dataset. In addition, the optimization module 245 may adjust the hyperparameters based on various factors such as the type and size of the dataset that is used to train the deep learning model. For example, if the training dataset consists of the historical data, then the hyperparameter values may be dynamically adjusted to a particular set of name/value pairs. If the training dataset consists of data harvested from the Internet-based electronic commerce platforms, then the hyperparameter values may be dynamically adjusted to another set of hyperparameter name/value pairs. Also, if the training dataset is a combination of the historical data and the data harvested from the Internet-based electronic commerce platform, then the hyperparameter values may be dynamically adjusted to yet another set of hyperparameter name/value pairs. For example, a rule may be used to determine a configuration file that includes hyperparameter name/value pairs based on the size and type of dataset such as if the dataset only includes historical data or is a combination of historical data and harvested data from electronic commerce platform.

Smart pricing engine 230 includes a machine learning module 235, a decision module 240, and an optimization module 245. Machine learning module 235 may be configured to predict the estimated recovery value of the asset using the XGB regressor which is a high performant boosting algorithm for predicting the estimated recovery value of assets. Machine learning module 235 may predict the recovery value of the asset using a machine learning model, referred herein simply as a model, that has been trained and/or validated using the multidimensional dataset or a subset thereof. Machine learning module 235 also uses various parameters like asset configuration, years old, manufacturer, model, and customer, etc. in the training and validation of the model as well as in predicting the recovery value of the asset. Machine learning module 235 may combine linear model solver and a tree learning algorithm which is capable of parallel computation for speed and efficiency. It uses many models as an ensemble and trains them in succession with each successive model added sequentially gets trained to correct the error made by the previous model. Although the XGB regression algorithm was used to describe the embodiments in the present disclosure, those skilled in the art will observe that other machine learning techniques such as adaptive boosting may be used while retaining the teachings of the present disclosure.

Decision module 240 may be configured to determine whether to apply or waive a recycling service fee when a customer requests to recycle an asset. The recycling service fee is a fixed cost that may be applied to each recycling request. Decision module 240 may use one or more policies and/or rules. For example, decision module 240 may apply the service if the recovery value is above a certain percentage than the service fee.

Smart pricing engine 230 and/or associated modules may be configured as microservices which can be called from sales system 210 and self-service portal 215 to assist customers in their decision on whether to recycle the asset by providing recovery value estimates in real-time. Thus, if the customer decide to recycle the asset, the customer can receive his payment at the point of asset transfer instead of waiting for the payment from the recycling partner after the recycling process.

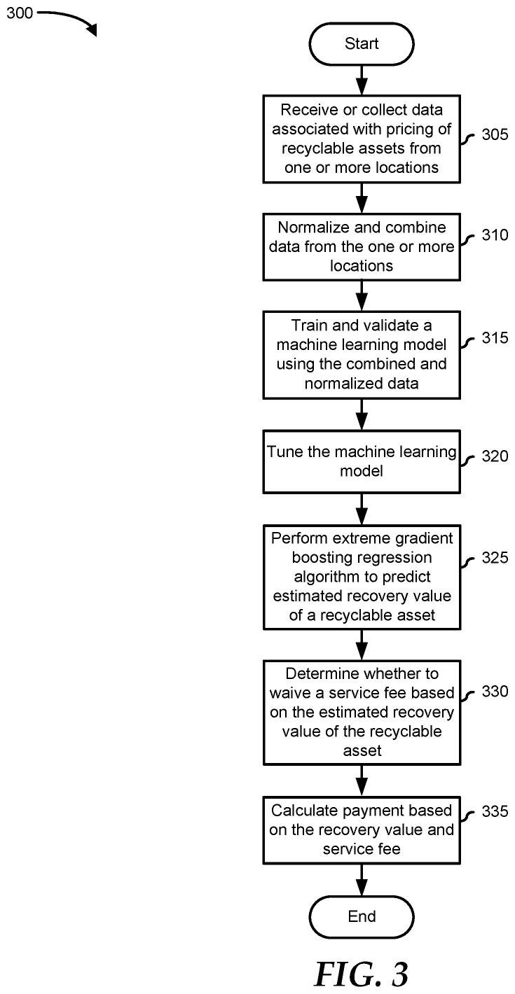

FIG. 3 illustrates a method 300 for a smart asset recovery management framework that utilizes artificial intelligence and/or machine learning techniques such as the XGB algorithm. While embodiments of the present disclosure are described in terms of environment 200 of FIG. 2, it should be recognized that other systems may be utilized to perform the described method.

Method 300 typically begins at block 305 where the method receives, collects, or harvests data associated with the recovery values of recyclable assets from one or more locations or sources. Method 300 may harvest or crawl data from past transactions, recycling partners, and commercial websites. The method proceeds to block 310 where the method may normalize and combine the data from the one or more locations to build a multidimensional dataset. Normalization may include pre-processing the dataset such as imputing missing or desired values, features, and attributes, removing outlier values that are not needed, and converting values such as from numerical to categorical.

The method may proceed to block 315 where the method may use a subset of the multidimensional dataset to train a model. Multidimensional datasets may be prepared from the historical settlement data along with harvested data from external commercial websites and recycling partners. The multidimensional dataset may be grouped according to a category such as the source of the data, the type of data, location of the recycled assets, the time period, or a combination thereof. The method may use another subset of the multidimensional dataset to validate the trained model. An accuracy rate or score of the trained model may be calculated during the validation.

The method may proceed to block 320 where the method tunes one or more hyperparameters of the model to increase the accuracy of the model. The hyperparameter may be the gamma, learning rate, maximum depth of a tree, etc. The gamma parameter is associated with a minimum loss reduction required to make a further partition on a leaf node of a tree. The size of the gamma may be directly proportional to how conservative the machine learning algorithm will be. The maximum depth of a tree parameter may be directly proportional to the complexity of the machine learning model. The more complex the machine learning model is, the more likely it is to overfit while the learning rate parameter may prevent overfitting.

The method may proceed to block 325, where the method may perform the XGB regression algorithm to predict a recovery value of a recyclable asset. The XGB algorithm implements an optimized gradient boosting decision tree algorithm and is used for supervised learning problems. The XGB algorithm uses the training dataset with one or more features xᵢ to predict a target variable yᵢ. The features may include model, manufacturer, asset type, year of manufacture, condition, and one or more physical configuration such as size and weight. The features may also include information associated with the attributes of the components of the recyclable asset such as its processor, memory, camera, disk drive, etc. Other information that is typically taken into consideration in predicting the target variable, herein the recovery value of the recyclable asset, includes the location or address of the recyclable asset and the customer's usage pattern of the recyclable asset including the asset's condition also referred as wear and tear.

The method may proceed to block 330, where the method determines whether to waive a service fee associated with recycling the asset by applying one or more rules. The determination may be based on the recovery value of the asset. For example, if the recovery value of the asset is smaller than the service fee, then the service fee may be waived. Otherwise, the service fee is deducted from the recovery value.

The method may proceed to block 335 where the method calculates the payment to be given to the customer for recycling the asset. The payment may be the recovery less the service fee. If the service fee is waived, then the service fee is zero. After calculating the payment to the customer, the method ends.

Although FIG. 3 show example blocks of method 300 in some implementation, method 300 may include additional blocks, fewer blocks, different blocks, or differently arranged blocks than those depicted in FIG. 3. Additionally, or alternatively, two or more of the blocks of method 300 may be performed in parallel.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionalities as described herein.

The present disclosure contemplates a computer-readable medium that includes instructions or receives and executes instructions responsive to a propagated signal; so that a device connected to a network can communicate voice, video or data over the network. Further, the instructions may be transmitted or received over the network via the network interface device.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or another storage device to store information received via carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

Although only a few exemplary embodiments have been described in detail above, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents but also equivalent structures.

What is claimed is:

1. A method comprising:
receiving, by a processor, historical data that includes configuration information and recovery values of recycled assets;
building a training dataset from a subset of the historical data;
building a validation dataset from another subset of the historical data;
training a machine learning model on the training dataset to learn the recovery values of the recycled assets;
subsequent to the training of the machine learning model, validating the machine learning model on the validation dataset;
tuning a hyperparameter of the machine learning model; and
predicting a recovery value of a recyclable asset using the machine learning model utilizing an extreme gradient boosting algorithm.

2. The method of claim 1, further comprising combining the historical data with data crawled from an Internet-based electronic commerce platform.

3. The method of claim 2, further comprising combining the historical data with data obtained from a recycling company.

4. The method of claim 3, further comprising building a multidimensional dataset that includes the historical data, the data crawled from the Internet-based electronic commerce platform, and the data obtained from the recycling partner.

5. The method of claim 1, further comprising determining whether to waive a service fee based on the recovery value of the recyclable asset.

6. The method of claim 1, wherein the tuning of the hyperparameter is based on an accuracy score of the machine learning model.

7. The method of claim 1, wherein the tuning of the hyperparameter is based on a size of the historical data.

8. The method of claim 1, wherein the configuration information includes a manufacturer, a type, a model, a location, and condition of each one of the recycled assets.

9. The method of claim 1, wherein the hyperparameter includes a maximum depth of a tree and samples on a leaf.

10. An information handling system, comprising:
a hardware processor; and
a memory device accessible to the hardware processor, the memory device storing instructions that when executed perform operations, including:
receiving historical data that includes configuration information and recovery values of recycled assets;
building a training dataset from a subset of the historical data;
building a validation dataset from another subset of the historical data;
training a machine learning model on the training dataset to learn the recovery values of the recycled assets;
validating the machine learning model based on the validation dataset;
tuning a hyperparameter of the machine learning model; and
predicting a recovery value of a recyclable asset using the machine learning model utilizing an extreme gradient boosting algorithm.

11. The information handling system of claim 10, the operations further comprising combining the historical data with data crawled from an Internet-based electronic commerce platform.

12. The information handling system of claim 10, the operations further comprising combining the historical data with data obtained from a recycling partner.

13. The information handling system of claim 10, the operations further comprising determining whether to waive a service fee based on the recovery value of the recyclable asset.

14. The information handling system of claim 10, wherein the tuning of the hyperparameter is based on an accuracy score of the machine learning model.

15. A non-transitory computer-readable medium including code that when executed performs a method, the method comprising:
receiving historical data that includes configuration information and recovery values of recycled assets;
training a machine learning model to learn the recovery values of the recycled assets based on a subset of the historical data;
validating the machine learning model based on another subset of the historical data;
tuning a hyperparameter of the machine learning model; and
predicting a recovery value of a recyclable asset using the machine learning model utilizing an extreme gradient boosting algorithm.

16. The method of claim 15, further comprising combining the historical data with the data crawled from an Internet-based electronic commerce platform.

17. The method of claim 15, further comprising combining the historical data with data obtained from a recycling partner.

18. The method of claim 15, further comprising building a multidimensional dataset based on the historical data with data crawled from an Internet-based electronic commerce platform and data from a recycling company.

19. The method of claim 15, further comprising determining whether to waive a service fee based on the recovery value of the recyclable asset.

20. The method of claim 15, wherein the tuning of the hyperparameter is based on an accuracy score of the machine learning model.
